(19) United States
(12) Patent Application Publication
(10) Pub. No.: US 2023/0278664 A1
(43) Pub. Date: Sep. 7, 2023

(54) DRIVE ASSEMBLY

(71) Applicant: Robert Bosch GmbH, Stuttgart (DE)

(72) Inventors: Harald Hundt, Aichelberg (DE); Julian Binder, Wannweil (DE); Peter Kimmich, Steinenbronn (DE); Sigmund Braun, Kusterdingen (DE)

(21) Appl. No.: 18/173,195

(22) Filed: Feb. 23, 2023

(30) Foreign Application Priority Data
Mar. 1, 2022 (DE) 10 2022 202 103.7

(51) Int. Cl. B62M 6/55; B62M 6/80; F16F 15/06

(52) U.S. Cl. CPC B62M 6/55; B62M 6/80; F16F 15/06

(57) ABSTRACT

A drive assembly of a vehicle which can be operated by means of muscle power and/or motor power. The drive assembly includes: a drive unit, a frame interface, wherein the drive unit is disposed at least partially between a first wall and a second wall of the frame interface, wherein the drive unit comprises a through-bore, two sleeves which are inserted into the through-bore of the drive unit on both sides, and a through-bolt which is inserted through the through-bore and the two sleeves and holds the drive unit on each of the two walls. The through-bolt braces the two walls against one another.

### CROSS REFERENCE

The present application claims the benefit under 35 U.S.C. § 119 of German Patent Application No. DE 10 2022 202 103.7 filed on Mar. 1, 2022, which is expressly incorporated herein by reference in its entirety.

### FIELD

The present invention relates to a drive assembly and a vehicle comprising the drive assembly.

### BACKGROUND INFORMATION

Drive assemblies comprising drive units which are held between two walls of a frame interface are available in the related art. The drive unit is screwed to the two oppositely disposed walls. A gap between the drive unit and one of the walls typically has to be bridged. To make this possible, a retaining plate can be provided on the drive unit, for example, which is elastically deformed to bridge the gap. However, this can have an adverse effect on the mechanical load and the tightness of the drive assembly.

### SUMMARY

A drive assembly according to the present invention provides a mounting of a drive unit inside a housing which is advantageous in terms of load is made possible. Particularly simple and cost-efficient production and assembly of the drive assembly is made possible as well. According to an example embodiment of the present invention, this may be achieved by a drive assembly comprising a drive unit and a frame interface. The drive unit is disposed at least partially between a first wall and a second wall of the frame interface. The first wall and the second wall are preferably connected to one another by means of a connecting wall, in particular such that the first wall, the second wall and the connecting wall together form a one-piece U-shaped frame. The drive unit comprises a through-bore. The drive assembly also comprises two sleeves which are inserted into the through-bore of the drive unit on both sides, i.e. at both ends of the through-bore, and a through-bolt which is inserted through the through-bore and the two sleeves. The through-bolt holds the drive unit on each of the two walls, in particular indirectly via the two sleeves. The two walls are braced against one another by means of the through-bolt.

In other words, a through-connection, which holds the drive unit to the frame interface by inserting a through-bolt through the drive unit, is provided in the drive assembly. This results in numerous advantages. On the one hand, it enables a particularly simple assembly and disassembly of the drive assembly to and from the frame interface. The through-bolt can be worked on the side of one of the two walls, for example, i.e. for instance inserted, rotated or pulled out. Because of the limited accessibility on the side of the chainring when used on an electric bicycle, this is particularly advantageous. The ability to work the through-bolt can therefore be provided on the opposite side. The use of a through-bolt with a relatively large diameter furthermore makes it possible to achieve a particularly robust connection, in particular with respect to transverse loads. This can also prevent slipping of a screw connection, for example. The sleeves can also be used to optimally set a desired load state of the drive unit. Appropriate design of the sleeves can provide a neutral installation state of the drive unit, for example, in which no axial forces, in particular with respect to a longitudinal axis of the through-bolt, act on the drive unit. The sleeves can alternatively be designed such that the bracing by means of the through-bolt causes a slight or a large compressive load on the drive unit in axial direction, for example, which can have an advantageously effect on a tightness of the drive unit with respect to fluid ingress. The sleeves enable particularly simple adaptability, for example to different frame interfaces and/or to different degrees of tolerance of the frame interface.

Preferred further developments and example embodiments of the present invention are disclosed herein.

According to an example embodiment of the present invention, each sleeve preferably comprises a shank and a flange. The shank is preferably hollow cylindrical, and the flange is preferably disposed at an axial end of the shank and has a larger outer diameter than the shank. The shank is disposed at least partially inside the through-bore and the flange is disposed outside the through-bore. The flange is in particular configured such that it can rest against an end face of the drive unit surrounding the through-bore and can precisely define an insertion depth of the shank of the sleeve. The desired mechanical load can thus be set particularly easily and precisely.

It is particularly advantageous if the flange of the sleeves can be provided with different thicknesses, in particular with respect to the axial direction of the sleeve. For example, the flange of a sleeve of a first embodiment can have a first thickness, whereas the flange of a sleeve of a second embodiment can have a second thickness which is at least 1.5 times, preferably at least twice, in particular at least three times, the first thickness. This results in the advantage that the width of the drive assembly, preferably measured along an axial direction of the through-bore, can be varied in a particularly simple and cost-efficient manner. For example, the width of the drive assembly can be adapted to frame interfaces having different widths by varying the thickness of the flanges of the sleeves, so that the drive assembly can be used particularly flexibly and cost-efficiently.

According to an example embodiment of the present invention, each sleeve particularly preferably comprises a damping element, which is disposed on a side of the flange facing the drive unit. The damping element is made of a vibration-damping material. The damping element is preferably made of an elastomer. The damping element produces a certain damping effect by being able to deform elastically between the flange and the drive unit. The drive assembly can thus be designed in a simple and cost-efficient manner such that the drive unit is held without play in the axial direction of the through-bore, for example, wherein the damping element is deformed or partially compressed under pressure. The damping element can also reduce a transmission of oscillations and vibrations between the drive unit and the frame interface. The damping element moreover advantageously provides a sealing effect between the sleeve and the drive unit.

The damping element preferably also surrounds the shank at least partially, preferably entirely, in peripheral direction. The damping element is therefore in particular configured as an overmolding of the shank and the side of the flange facing the shank. The damping element thus provides the advantage of a vibration-mechanically optimized fastening of the drive unit to the frame interface. This has a particularly advantageous effect on a durability of screw connections, because the vibration-damping effect in particular reduces a transmission of oscillations and vibrations and changing dynamic loads as a result of the resilient and damping properties of the damping element. This also reduces or prevents changing mechanical loading of the screw connection, thus making it possible to provide a high degree of durability. An occurrence of unwanted noises, for example, can moreover be reduced as well. The damping element also allows a certain level of tolerance compensation. In addition, there is the advantage of additional protection against corrosion, in particular galvanic corrosion, for example when the drive unit comprises a housing made of magnesium or aluminum, and the sleeves are made of steel, for example. An axial and radial sealing effect can furthermore be provided on the drive unit.

According to an example embodiment of the present invention, the two sleeves are further preferably designed such that, when they are fully inserted into the through-bore and not braced, they are disposed inside the through-bore at a predefined axial spacing to one another. In other words, a sum of the axial lengths of the sleeves when they are inserted into the through-bore and not braced is less than a total axial length of the through-bore.

The predefined axial spacing is preferably designed such that, in the braced state of the two walls which is caused by the through-bolt, the axial spacing is compensated by an elastic deformation of the damping element. This means that the sleeves touch inside the through-bore. In other words, the two sleeves are designed such that, in the braced state when the two sleeves touch inside the through-bore, the respective damping element of the two sleeves is elastically deformed, in particular compressed between the flange and the drive unit. This makes it particularly easy to set a predetermined load state of the drive unit with a low predetermined compressive load. A seal is moreover reliably ensured by means of the deformed or compressed damping element. The fact that the sleeves touch one another furthermore ensures that the axial mechanical forces are absorbed via the sleeves, so that the through-bolt can be screwed on with high torque, for example, without excessive mechanical loading of the drive unit. This also enables a particularly stable screw connection.

The sleeves preferably touch inside the through-bore. The two sleeves are designed such that they are clamped between the two walls in the axial direction of the through-bolt when the two walls are screwed together by means of the through-bolt. Thus a particularly robust fastening of the drive unit to the frame interface can be provided with few components and consequently in a lightweight and cost-efficient manner. Because the sleeves touch inside the through-bore, the axial forces that can occur as a result of fastening to the frame interface can be absorbed by the sleeves so that the mechanical load on the drive unit is reduced.

The two sleeves and the drive unit are particularly preferably designed such that the drive unit is held between the two walls without tension. In detail, the two sleeves can be configured such that they touch inside the through-opening and respectively extend axially beyond the through-opening. As a result, in the braced state, the two walls rest only against the sleeves and not against the drive unit. In other words, the two sleeves form a spacer between the two walls. Thus a substantially load-free assembly of the drive unit to the frame interface can be provided.

According to an example embodiment of the present invention, the first wall preferably comprises a predetermined bending point. This means that, by bracing the two walls by means of the through-bolt, selectively only the first wall is deformed, in particular bent in the direction of the second wall. The predetermined bending point can be configured as a sectionally thinner wall thickness of the first wall compared to the second wall, for example. This makes it particularly easy to provide a desired and defined arrangement of the drive unit relative to the frame interface. This also has an advantageous effect on other components, in particular when used on an electric bicycle. The second wall can be disposed on the side of the chainring, for instance. Because of the predetermined bending point on the first wall, the relative arrangement of all parts and components on the chainring side remains independent of the screw connection of the drive unit and the frame interface and is thus precisely positioned.

The shank of each sleeve further preferably comprises a pressing region. A press fit is formed between the pressing region and the through-opening. This enables a particularly reliable and defined mounting and transmission of force between the sleeves and the drive unit.

The pressing region is preferably disposed, in particular directly, adjacent to the flange. The shank of each sleeve further comprises a tapering region which has a smaller outer diameter than the pressing region. The tapering region is thus in particular disposed on a side of the pressing region opposite to the flange. This allows the tapering region to be inserted easily and smoothly into the through-bore of the drive unit in order to enable easy insertion of the sleeves into the through-bore.

According to an example embodiment of the present invention, the through-bore preferably comprises a centering region which is located in the center of the through-bore and has a smaller inner diameter than the rest of the through-bore. The centering region is provided for centering the two sleeves inside the through-bore, in particular by means of the respective tapering regions of the sleeves. A clearance fit is preferably formed between each tapering region and the centering region, so that smooth insertion of the sleeves is possible, but the centering regions are aligned precisely in the center of the through-bore for optimum alignment of the two sleeves.

The through-bolt is particularly preferably configured as a screw and screwed into an internal thread of the second wall. Thus a particularly simple, cost-efficient drive assembly can be provided, which is also lightweight because there are fewer components.

The through-bolt is preferably configured as a screw and screwed into a nut disposed on the second wall. Thus a particularly robust screw connection can be provided, for example because the through-bolt and the nut can be made of a harder material than the frame interface. Using through-bolts and nuts made of steel, for example, makes it possible to use a particularly high torque for screwing. Moreover, if the internal thread is damaged, the nut can easily be replaced. The use of a nut also has the further advantage that, due to a radially specified play, it represents a tolerance compensation relative to the wall opening of the first wall and is therefore always precisely aligned.

The nut is preferably disposed in a non-rotatable manner in a recess of the second wall. The nut and recess can have a non-circular geometry, for example, for instance in the form of tangential flats, in particular with respect to an axis of a through-opening through the second wall. A particularly simple assembly of the drive assembly can thus be made possible.

According to an example embodiment of the present invention, the drive unit preferably comprises a motor and/or a transmission. The specific arrangement and mounting between the walls of the frame interface can provide an optimal reliable connection with advantageous distribution of mechanical forces in order to enable a long service life of the drive unit. Moreover, a low weight of the drive assembly can be made possible in a simple and cost-efficient manner.

The shank of each sleeve is preferably inserted into the through-opening of the drive unit. The flange comprises a plurality of projecting form-fit elements on a side facing the respective wall. The form-fit elements are configured to press into this wall when the sleeve is screwed to the respective wall. The form-fit elements in particular cause plastic deformation of the wall by pressing into the wall, in particular such that the form-fit elements and the plastically deformed region of the wall create a form fit in a plane perpendicular to the screw axis. This means that the sleeve comprises the projecting form-fit elements on the surface of the flange which partially dig into the wall when the sleeve and the wall are screwed together, in particular to create a micro form fit in the plane of the wall surface. Thus a particularly firm connection of the drive unit to the frame interface can be provided, because slipping between the sleeve and the wall can be prevented.

According to an example embodiment of the present invention, each form-fit element preferably comprises a pyramid which projects from a surface of the flange of the sleeve. Alternatively, each form-fit element comprises a cone which projects from a surface of the flange of the sleeve, for example. In other words, a plurality of pyramid tips which project from the surface of the flange are provided as form-fit elements. The pyramids are particularly preferably pointed, and in particular have an opening angle of less than 60°, preferably less than 45°, so that they can penetrate the wall particularly easily. Such a configuration with pointed pyramids as form-fit elements is particularly advantageous for screwing the drive unit to carbon frames, i.e. to frame interfaces which consist at least in part of a fiber-reinforced, preferably carbon-fiber-reinforced, plastic. This has the advantage that the pointed pyramids can impress themselves into the network structure of the carbon without damaging it. The fibers are in particular not disrupted when the pyramids penetrate, but can yield and wrap around the respective pyramid.

According to an example embodiment of the present invention, each form-fit element further preferably comprises a recess in the surface of the flange adjacent to, for example surrounding, the pyramid. The recess is preferably configured as an annular groove. Particularly preferably, a single recess is configured in the surface of the flange, on the radial inner side and/or outer side of which the pyramids are disposed. Alternatively, a separate recess can be configured for each pyramid, wherein the recess is in particular disposed directly adjacent to the pyramid. The recess can accommodate material of the wall displaced by the penetration of the pyramid into the wall, for example, in order to enable a reliable and defined contact of the surface of the flange with the wall.

At least one of the sleeves preferably comprises a shank and a flange. The shank is in particular inserted into the corresponding opening of the drive unit. The flange is preferably disc-shaped. The flange comprises a taper at a radially outer end. The taper is disposed on the side of the flange facing the shank. A taper is in particular considered to be a reduction in the thickness of the flange, in particular in the axial direction of the sleeve. The taper is in particular a difference of the maximum thickness and the minimum thickness of the flange, wherein this difference is preferably at least 50%, preferably a maximum of 150%, of a wall thickness of the shank of the sleeve. The taper of the flange is compensated by the damping element. In other words, a thickness of the damping element in the region of the taper is greater than on the remainder of the flange. An overall thickness of the damping sleeve in axial direction in the region of the flange is preferably constant. Alternatively preferably, the damping element can be uncovered at a radially outer end on the side facing the shank. Due to the taper of the flange and the thicker damping element in this region, a softer zone of the damping sleeve can be provided in this region, which enables a particularly good sealing effect between the damping sleeve and the drive unit.

The drive unit further preferably comprises at least one projecting annular rib which is disposed concentrically to one of the two openings. The annular rib preferably has a conical or trapezoidal cross-section. The projecting annular rib and the taper of the flange of the sleeve are particularly preferably disposed on the same radius with respect to an opening axis of the opening of the drive unit. In other words, the projecting annular rib and the taper of the flange of the sleeve are disposed at the same height relative to the radial direction of the opening of the drive unit. The projecting annular rib can thus plunge optimally into the thicker region of the damping element during the assembly of the drive assembly, as a result of which a particularly good sealing effect can be provided between the damping sleeve and the drive unit.

The flange of at least one sleeve further preferably has a predetermined thickness, in particular in the direction parallel to a longitudinal direction of the sleeve, which is substantially equal to a wall thickness of the shank, in particular in radial direction. Alternatively preferably, the flange of at least one sleeve further preferably has a predetermined thickness, in particular in the direction parallel to a longitudinal direction of the sleeve, which is at least 1.5 times, preferably at least twice, a wall thickness of the shank, in particular in radial direction. A variable width of the drive assembly can thus be provided, which enables adaptation to frame interfaces having different widths in a particularly simple and cost-efficient manner.

The present invention is furthermore directed to a vehicle, preferably a vehicle which can be operated by means of muscle power and/or motor power, preferably an electric bicycle, which comprises the drive assembly according to the present invention disclosed herein. The frame interface can be part of a vehicle frame of the vehicle, for example.

The vehicle preferably comprises a vehicle frame. The frame interface of the drive assembly is an integral part of the vehicle frame, i.e., the vehicle frame is configured as a one-piece component with the frame interface, wherein the drive unit is preferably connected to the frame interface directly, i.e. in particular without additional components in between.

Alternatively preferably, the frame interface of the drive assembly and/or one or both of the walls of the frame interface is configured as a separate component to the vehicle frame and is connected, preferably screwed, to the vehicle frame. The drive unit can thus be fastened indirectly to the frame interface, for example.

The vehicle particularly preferably further comprises a chainring which is connected to an output shaft of the drive unit. The second wall of the drive assembly is disposed on the side of the chainring. In particular if a fastening on the second wall is configured as a fixed bearing and a fastening on the first wall is configured as a floating bearing, an optimal direct transmission of force between the drive unit and the chainring can take place. This also ensures precise positioning of the chainring, i.e., an exact chain line.

### BRIEF DESCRIPTION OF THE DRAWINGS

The present invention will be described in the following with reference to embodiment examples in conjunction with the figures.

In the figures, functionally equivalent components are identified with the same respective reference signs.

FIG. 1 shows a simplified schematic view of a vehicle comprising a drive assembly according to a first embodiment example of the present invention.

FIG. 2 shows a sectional view of the drive assembly of FIG. 1 fully screwed together.

FIG. 3 shows a sectional view of a drive assembly according to a second embodiment example of the present invention not screwed together.

FIG. 4 shows a sectional view of the drive assembly of FIG. 3 partially screwed together.

FIG. 5 shows a sectional view of the drive assembly of FIGS. 3 and 4 fully screwed together.

FIG. 6 shows a sectional view of a drive assembly according to a third embodiment example of the present invention fully screwed together.

FIG. 7 shows a detail of a drive assembly according to a fourth embodiment example of the present invention.

FIG. 8 shows a detail sectional view of FIG. 7.

FIG. 9 shows a detail sectional view of a drive assembly according to a fifth embodiment example of the present invention.

FIG. 10 shows a further detail sectional view of the drive assembly of FIG. 9.

FIG. 11 shows a sectional view of a drive assembly according to a sixth embodiment example of the present invention.

FIG. 12 shows a sectional view of a drive assembly according to a seventh embodiment example of the present invention.

### DETAILED DESCRIPTION OF EXAMPLE EMBODIMENTS

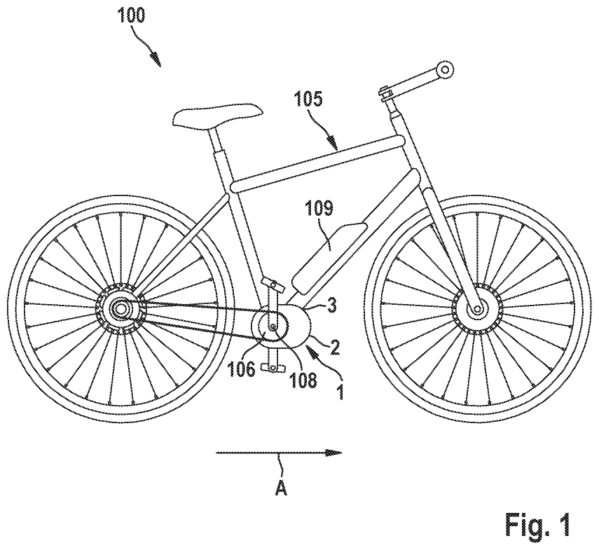

FIG. 1 shows a simplified schematic view of a vehicle 100 which can be operated by means of muscle power and/or motor power and comprises a drive assembly 1 according to a first embodiment example of the present invention. The vehicle 100 is an electric bicycle. The drive assembly 1 is disposed in the region of a bottom bracket and comprises a drive unit 2. The drive unit 2 comprises an electric motor and a transmission, and is provided to support the rider's pedal force generated by muscle power by means of a torque generated by the electric motor. The drive unit 2 is supplied with electrical power by an electrical energy store 109.

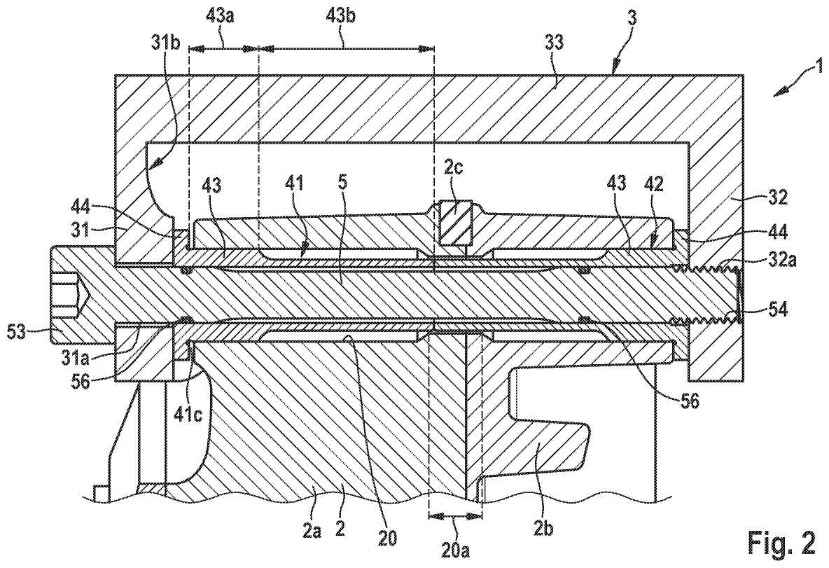

The drive assembly 1 of the first embodiment example is shown in a sectional view in FIG. 2. The drive assembly 1 comprises a U-shaped frame interface 3, inside which the drive unit 2 is partly accommodated. The frame interface 3 is an integral part of a vehicle frame 105 of the vehicle 100 (see FIG. 1). The frame interface 3 comprises a first wall 31 and a second wall 32, between which the drive unit 2 is disposed. The first wall 31 and the second wall 32 are connected to one another via a connecting wall 33 and are thus configured as a one-piece component.

The drive unit 2 is fastened to the frame interface 3 by means of a through-bolt connection, as described in further detail below.

In detail, the drive unit 2 comprises a through-bore 20 that passes all the way through the drive unit 2 in transverse direction. The through-bore 20 is in particular configured in a housing, which is preferably made of aluminum or magnesium, of the drive unit 2. The housing of the drive unit 2 can be configured in two parts, wherein a housing seal 2c disposed between the two housing halves 2a, 2b.

Two sleeves 41, 42 are inserted into the through-bore 20. The two sleeves 41, 42 are each inserted into the through-bore 20 from a respective side, i.e. at an axial end of the through-bore 20. The sleeves 41, 42 are preferably made of aluminum or steel.

Each sleeve 41, 42 comprises a shank 43, which is substantially hollow cylindrical and is inserted into the through-bore 20, and a flange 44. The flange 44 is disposed outside the through-bore 20 and has a larger outer diameter than the shank 43.

The shank 43 comprises a pressing region 43a, which is disposed directly adjacent to the flange 44. Adjacent to the pressing region 43a, there is also a tapering region 43b on the shank 43. The pressing region 43a is configured such that a press fit, i.e. an interference fit, is configured between the pressing region 43a and the through-bore 20. The tapering region 43b has a smaller outer diameter than the pressing region 43a, so that the sleeves 41, 42 can easily be inserted into the through-bore 20.

A tapering region 20a, in which an inner diameter of the through-opening 20 is tapered, is configured in the center of the through-bore 20. A clearance fit is preferably configured between the tapering region 20a and the tapering regions 43b of the sleeves 41, 42. The tapering region 20a consequently brings about a centering of the tapering regions 43b and thus a particularly precise arrangement of the sleeves 41, 42.

The two sleeves 41, 42 are preferably configured identically for simple and cost-efficient production.

The axial lengths of the sleeves 41, 42, in particular of the respective shank 43, are designed such that the sleeves 41, 42 touch inside the through-bore 20 when they are inserted. The axial lengths of the shanks 43 are configured such that only one of the flanges 44 of the two sleeves 41, 42 can rest against the drive unit 2, in which case there is a gap 41m between the other flange 44 and the drive unit 2. For this purpose, an axial length of each shank 43 is preferably slightly more than half the axial length of the through-bore 20.

The sleeves 41, 42 are pressed into the through-bore 20 such that the flange 44 of the second sleeve 42 rests against the drive unit 2 on the side of the second wall 32 and the gap 41m is present between the flange 44 of the first sleeve 41 on the side of the first wall 31 when the two sleeves 41, 42 touch inside the through-bore 20.

The drive assembly 1 also comprises a through-bolt 5, which is inserted through the through-bore 20 and the two sleeves 41, 42. The through-bolt 5 is configured as a screw and comprises a bolt head 53 at one axial end and an external thread 54 at the other axial end, wherein the external thread 54 extends only over a portion of the through-bolt 5.

The through-bolt 5 is screwed into an internal thread 32a of the second wall 32 by means of the external thread 54. The internal thread 32a is configured directly in a through-opening of the second wall 32. The bolt head 53 is located on the side of the first wall 31, and in particular rests against an outer side of the first wall 31.

A clearance fit is preferably configured between the through-bolt 5 and an inner through-opening of the sleeves 41, 42 to enable simple insertion. In the center, the through-bolt 5 preferably comprises a tapering of its outer diameter in order to enable particularly smooth insertion. A seal, for example an O-ring seal 56, is preferably disposed between the through-bolt 5 and the sleeve 41 and 42 in the regions of the clearance fit, in order to prevent fluid ingress into the interior of the sleeves 41, 42 and into the interior of the through-bore 20.

The through-bolt 5 is screwed in such that it braces the two walls 31, 32 against one another in the axial direction of the through-bolt 5. The first wall 31 comprises a predetermined bending point 31b, which causes the first wall 31 to be bent in the direction of the second wall 32 as a result of the bracing by means of the through-bolt 5. The second wall 32 is preferably designed to in particular be rigid, so that it does not deform. Since the drive unit 2 with the sleeves 41, 42 projecting from the through-opening 20 is disposed between the two walls 31, 32, the deformation of the first wall 31 is limited by the two sleeves 41, 42. The two sleeves 41, 42 are thus braced against one another in axial direction by the through-bolt 5. The gap 41m between the flange 44 of the first sleeve 31 and the drive unit 2 ensures that this bracing does not lead to any clamping, i.e. no compressive loading, of the drive unit 2 in axial direction between the two walls 31, 32. In other words, the two sleeves 41, 42 provide a neutral installation state with no tensile or compressive loading of the drive unit 2.

The special through-bolt connection of the drive assembly 1 provides numerous advantages. For example, the use of the through-bolt 5 and the bracing of the two walls 31, 32 with said through-bolt allows a particularly robust fastening of the drive unit 2. A screw connection can in particular take place with high torque. Absorbing the compressive forces by means of the sleeves 41, 42 makes it possible to prevent impermissibly high mechanical loading of the drive unit 2 in a particularly reliable manner. A tolerance position of the drive assembly 1 can furthermore be set in a defined manner simply and cost-efficiently, for example by adapting the sleeves 41, 42. The through-bolt connection also allows a particularly simple assembly of the drive assembly 1, because the through-bolt 5 can only be inserted, and the through-bolt 5 can only be worked to screw it in, from one side, namely from the side of the first wall 31. This is particularly advantageous in the case of limited accessibility on the side of the second wall 32, for example if there is a chainring 106 (see FIG. 1) on this side.

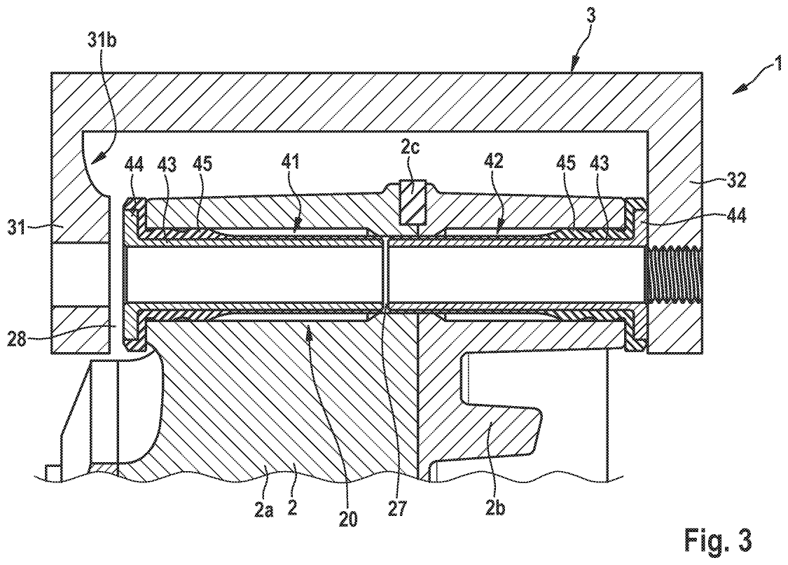

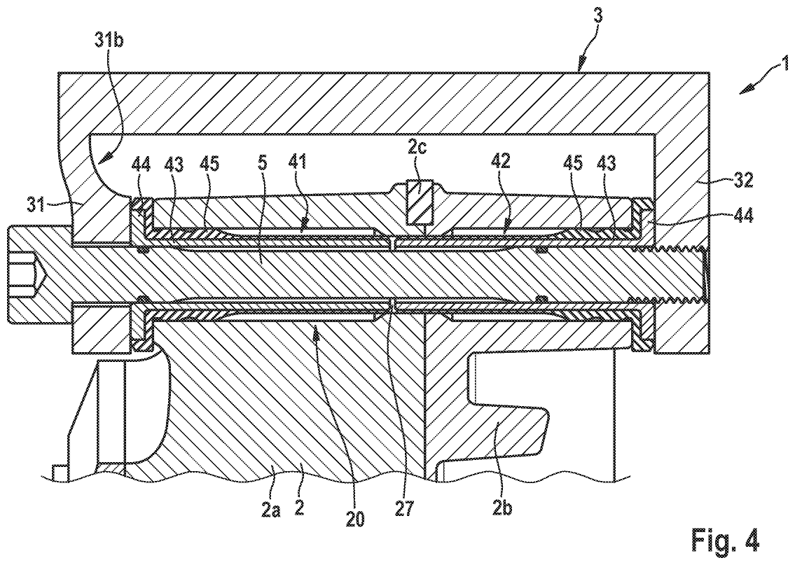

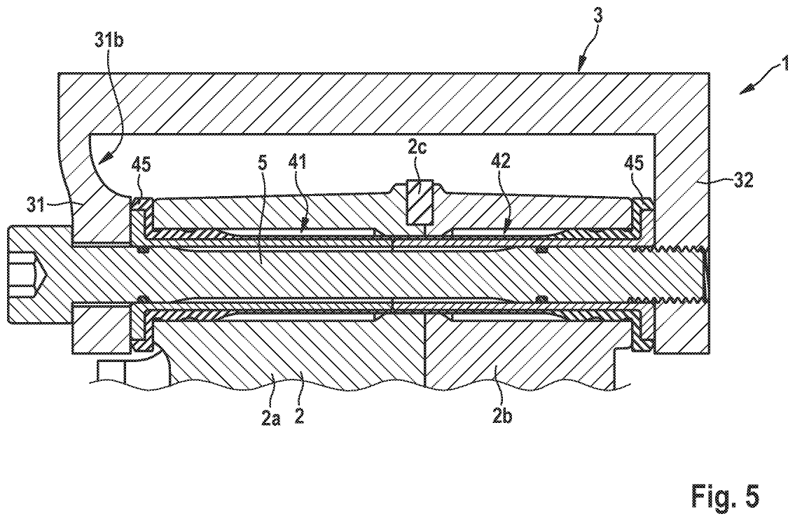

FIG. 3 shows a sectional view of a drive assembly 1 according to a second embodiment example of the present invention. The drive assembly 1 is only partially assembled in FIG. 3 and is shown not screwed together. In FIG. 4, the drive assembly 1 of the second embodiment example is shown fully assembled and partially screwed together. In FIG. 5, the drive assembly 1 of the second embodiment example is shown fully screwed together. The second embodiment example substantially corresponds to the first embodiment example of FIG. 2, with the difference being an alternative configuration of the sleeves 41, 42.

In the second embodiment example, each sleeve 41, 42 additionally comprises a damping element 45, which is made of an elastic and vibration-damping material. The damping element 45 is in particular made of an elastomer. In detail, a respective radially outer outer side of the shank 43, the flange 44, and the side of the flange 44 that faces the drive unit 2, is covered or coated with the damping element 45. The damping element 45 is thus preferably configured as an overmolding of the sleeve 41, 42.

In the second embodiment example, the axial lengths of the shanks 43 of the sleeves 41, 42 are furthermore configured differently from those in the first embodiment example. In detail, they are configured such that, when fully inserted into the through-opening 20 (see FIG. 3), there is a predefined axial spacing 27, i.e. a gap, between the two sleeves 41, 42 inside the through-opening 20. A state is considered, in which the two sleeves 41, 42 are not braced, but the damping element 45 rests against the drive unit 2 in the region of each flange 44 of each sleeve 41, 42. The axial lengths of the two shanks 43 are in particular less than half the axial length of the through-opening 20 by a predetermined difference, wherein the predetermined difference is less than twice the thickness of one of the damping elements 45 in the region of the flange 44.

In the not braced state shown in FIG. 3, there is a predefined gap 28 between the first wall 31 and the first sleeve 41.

This special coordination of the lengths of the two sleeves 41, 42 and the through-bore 20 ensures that the respective part of the damping element 45 of each sleeve 41, 42 positioned between the flange 44 and the drive unit 2 is partially compressed or clamped between the flange 44 and the drive unit 2 by the bracing by means of the through-bolt 5 and thus elastically deformed. This is illustrated by FIGS. 4 and 5. FIG. 4 shows a state in which the through-bolt 5 is tightened to such an extent that the first wall 31 just rests against the flange 44 of the first sleeve 41. Further tightening of the through-bolt 5 results in further bracing, such that the elastic damping element 45 deforms and the axial spacing 27 between the two sleeves 41, 42 is compensated, that is until the sleeves 41, 42 touch inside the through-opening 20. This state is shown in FIG. 5. The damping elements 45 can thereby partially be pushed radially outward by the bracing.

The damping elements 45 and the corresponding design of the sleeves 41, 42 with an axial spacing 27 in the not braced state result in a slight compressive load being applied to the drive unit 2 in the braced state. This can have an advantageous effect on a tightness of the drive unit 2 itself. The elastic deformation of the damping elements 45 moreover enables a particularly reliable seal between the sleeves 41, 42 and the drive unit 2.

In addition to the advantageous accessibility and simplified assembly of the drive assembly 1, the special screw connection of the drive unit 2 to the frame interface 3 also provides the advantage of a direct transmission of force between the output shaft 108 and the frame interface 3. The output shaft 108 is connected to the chainring 106 (see FIG. 1) in a rotationally fixed manner. The output shaft 108 can be driven on the one hand by the muscle power of the rider and on the other by the motor power of the drive unit 2. The chainring 106 is always located on the side of the second wall 32. The higher mechanical forces on the chainring side can be absorbed particularly well by the direct and robust connection of the drive unit 2 to the second wall 32. This also ensures a defined position of the chainring 106 in relation to an axial direction of the output shaft 108 and relative to the frame interface 3, which provides the advantage of a reliably precisely disposed chain line.

Connecting the drive unit 2 and the frame interface 3 via the damping elements 45 moreover provides the advantage of a vibration-decoupled mounting of the drive unit 2 on the vehicle 100. In addition to preventing or reducing a transmission of acoustic vibrations, which has an advantageous effect on noise reduction during operation of the vehicle 100, a transmission of mechanical vibrations is reduced or prevented as well. A damaging effect of such vibrations on the screw connection can thus be prevented or reduced. This means that loosening or unscrewing of the screw connection can be prevented or reduced. The elasticity of the damping element 45 itself can moreover provide a certain tolerance compensation, for example with respect to a coaxiality of the bores or openings or the like.

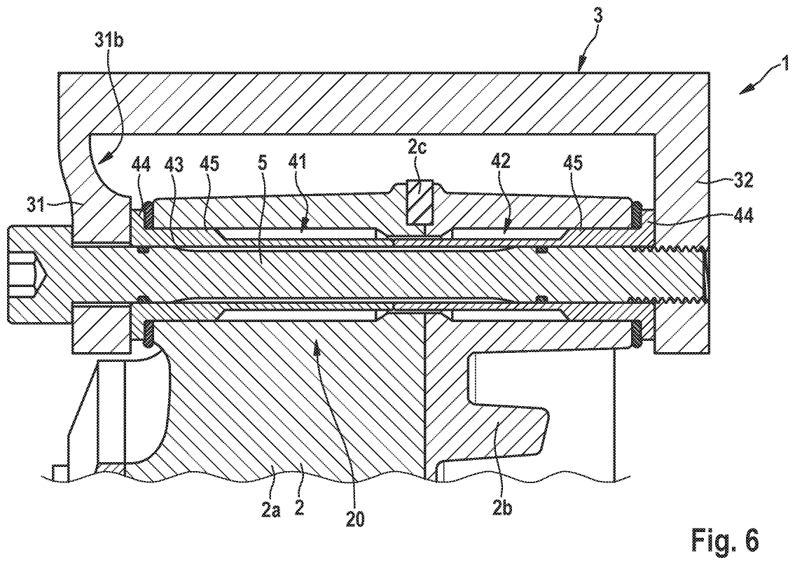

FIG. 6 shows a sectional view of a drive assembly 1 according to a third embodiment example of the present invention. The third embodiment example substantially corresponds to the second embodiment example of FIGS. 3 to 5, with the difference that the damping element 45 is disposed only on the flange 44 of the respective sleeve 41, 42. In other words, in each case, the damping element 45 is disc-shaped and is disposed only between the side of the flange 44 facing the drive unit 2 and the drive unit 2. The third embodiment example can in particular be regarded as a combination of the first embodiment example and the second embodiment example.

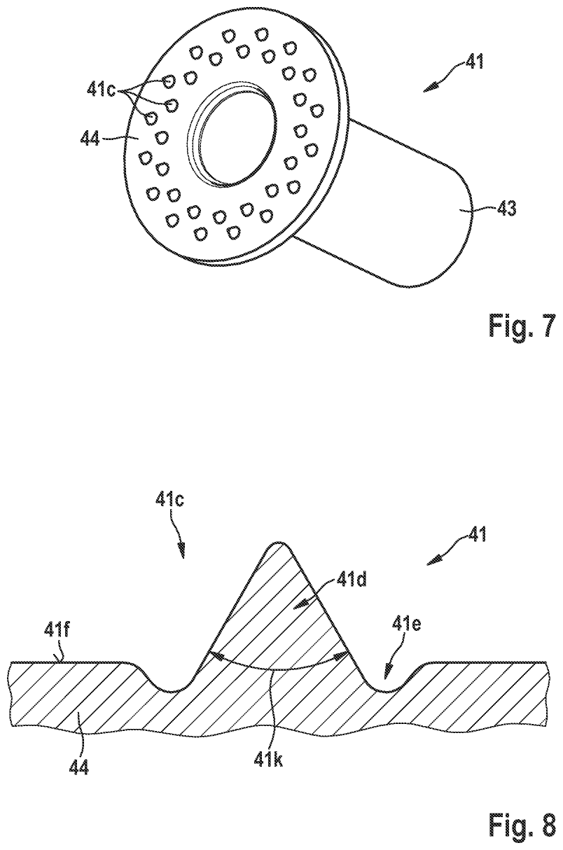

FIG. 7 shows a detail of a drive assembly 1 according to a fourth embodiment example of the present invention. The fourth embodiment example substantially corresponds to the first embodiment example of FIGS. 1 to 2, with the difference being alternative sleeves 41, 42.

Only one of the two sleeves 41, 42 is shown in FIG. 7, wherein the two sleeves 41, 42 are preferably configured identically. This sleeve 41 is shown in FIG. 8 in a perspective view.

The sleeve 41 comprises a shank 43 and a flange 44. The shank 43 is inserted into the through-opening 20 of the drive unit 2. The flange 44 is provided to rest against an inner side of the respective wall 31, 32 of the frame interface 3 (see e.g. FIG. 2). On the side assigned to the wall 31, 32, the flange 44 of the sleeve 41 comprises a plurality of projecting form-fit elements 41c. The form-fit elements 41c are preferably disposed in one or more, preferably two as in FIG. 7, circles that are concentric to the through-opening of the sleeve 41.

A single form-fit element 41c of the sleeve 41 of FIG. 7 is shown in a detail sectional view in FIG. 8. Each form-fit element 41c comprises a pyramid 41d which projects from a surface 41f of the flange 44. Alternatively preferably, each form-fit element 41c can also comprise a projecting cone. The pyramid 41d is configured as a straight pyramid and has an opening angle 41k of preferably less than 60°.

The pyramids 41d have the effect that they press into the surface of the wall 31, 32, i.e. plastically deform said wall, when the sleeve 41 is screwed to the wall 31, 32. This creates a micro form fit between the sleeve 41 and the wall 31, 32 in a plane perpendicular to the screw axis, as a result of which a particularly firm connection of the drive unit 2 and the frame interface 3 to one another can be made possible. Slipping of the drive unit 2 relative to the frame interface 3 can thus reliably be prevented.

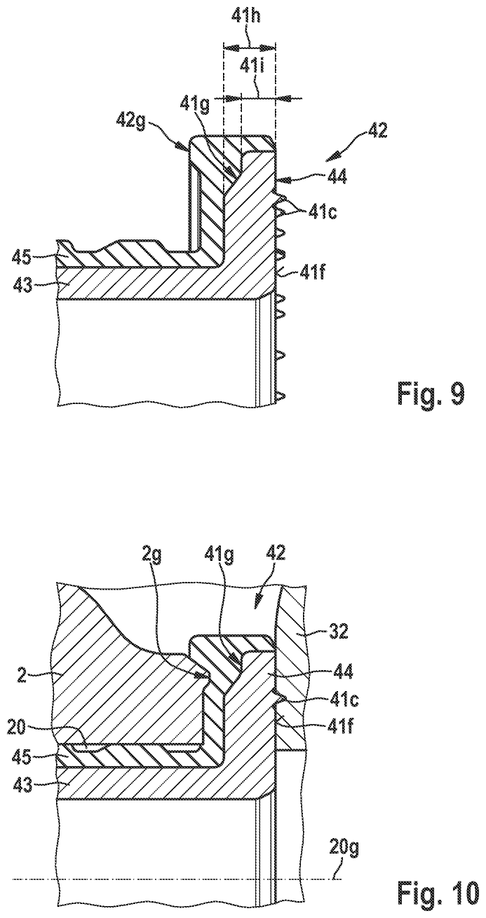

In addition to the pyramid 41d, each form-fit element 41c comprises a respective recess 41e, which is configured on an outer perimeter of the pyramid 41d and in the surface 41f of the flange 44. The recess 41e can accommodate material of the wall 31, 32 displaced by the penetration of the pyramid 41d into the wall 31, 32, for example, so that the wall 31, 32 and the flange 44 can reliably precisely rest flat on top of one another. One recess 41e can be provided for each pyramid 41d, for example, which partly or entirely surrounds the pyramid 41d. Alternatively preferably, a single recess 41e can be configured in the surface 41f of the flange 44, on the radial inner side and/or outer side of which the pyramids 41d are disposed FIG. 9 shows a detail sectional view of a drive assembly 1 according to a fifth embodiment example of the present invention. FIG. 9 shows only one of the damping sleeves, namely the sleeve 42 on the side of the second wall 32. The first sleeve 41 on the first wall 31 is preferably configured identically. The fifth embodiment example substantially corresponds to the second embodiment example of FIGS. 3 to 5, with the difference being an alternative configuration of the sleeve 42 in the region of the flange 44. The sleeve 42 at a radially outer end of the flange 44 comprises a taper 41g on the side of the flange 44 facing the shank 43. The taper 41g is configured such that a difference between the maximum thickness 41h and a minimum thickness 41i of the flange 44 corresponds to at least 50%, preferably at most 150%, of a wall thickness 43h of the shank 43 of the sleeve 42. The thicknesses along a direction parallel to a longitudinal axis of the sleeve 42 are considered.

The damping element 45 is configured such that it compensates the taper 41g of the flange 44. The damping element 45 further comprises a thickening 42g at a radially outermost Ende. There is therefore a particularly thick damping element 42 at the radially outer end of the flange 44. This has an advantageous effect on an optimal seal between the sleeve 42 and the drive unit 2.

This seal is further supported by a projecting annular rib 2g of the drive unit 2, which is provided in the fifth embodiment example as shown in FIG. 10. The projecting annular rib 2g has a trapezoidal cross-section and is disposed concentrically to the through-opening 20 of the drive unit 2. When the sleeve 42 is pressed into the through-opening 20, the projecting annular rib 2g and the taper 41g of the sleeve 42 are disposed on the same radius with respect to the opening axis 20g of the through-opening 20. As a result, the projecting annular rib 2g plunges into the soft zone of the damping element 45 in the region of the taper 41g when the sleeve 42 and the drive unit 2 are pressed against one another when fully screwed together. The elasticity of the damping element 45 thus enables optimal sealing at the drive unit 2.

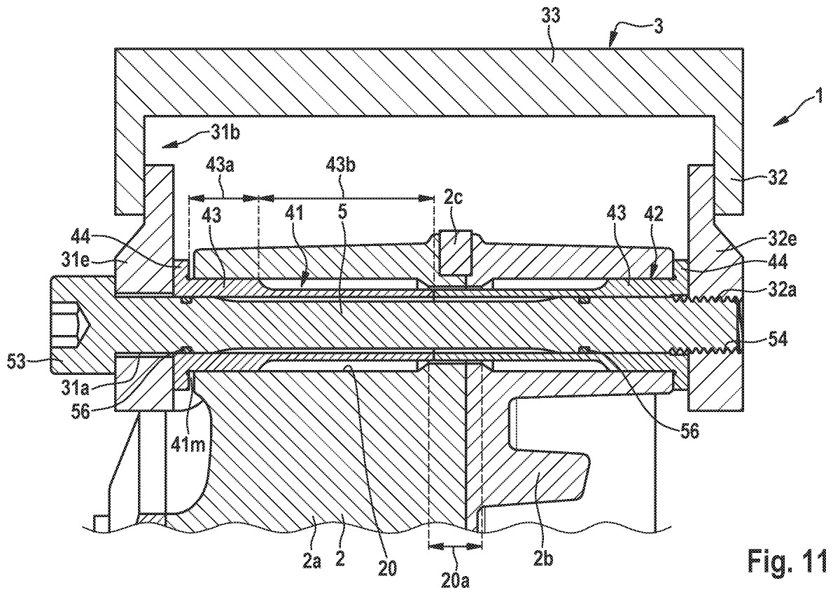

FIG. 11 shows a sectional view of a drive assembly 1 according to a sixth embodiment example of the present invention. The sixth embodiment example substantially corresponds to the first embodiment example of FIGS. 1 to 2, with the difference that the drive unit 2 is indirectly screwed to the frame interface 3.

In detail, the two walls 31, 32 to which the drive unit 2 is screwed here are configured as separate components to the frame interface 3. The walls 31, 32 can be configured as retaining plates, for example. The walls 31, 32 can be connected to frame walls 31e, 32e by means of (not depicted) additional screw connections and/or weld connections. A particularly high degree of flexibility of the drive assembly 1 can thus be provided.

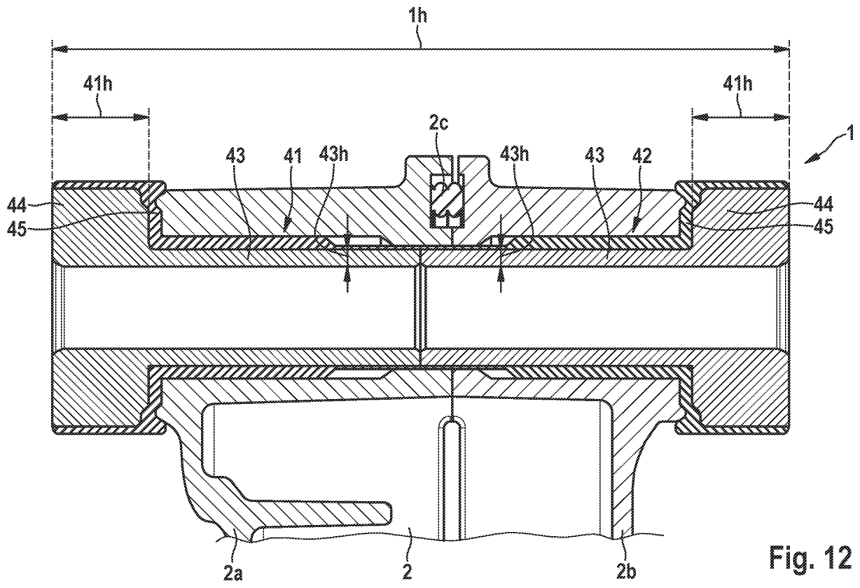

FIG. 12 shows a sectional view of a drive assembly 1 according to a seventh embodiment example of the present invention. The seventh embodiment example substantially corresponds to the fifth embodiment example of FIGS. 9 and 10, with the difference that alternative sleeves 41, 42 are used. In detail, the flanges 44 of the sleeves 41, 42 are thicker in the seventh embodiment example of FIG. 15 than in the fifth embodiment example. In detail, the thickness 41h of the flanges 44 in the seventh embodiment example is a multiple, preferably at least three times, a wall thickness 43h of the corresponding shank 43 of the respective sleeve 41, 42. As a result, an overall width 1h of the drive assembly 1 can be larger compared to the fifth embodiment example, in which the thickness 41h of the flange 44 is approximately equal to the wall thickness 43h of the shank 43, for example. The seventh embodiment example of FIG. 12 thus illustrates that, by modifying the sleeves 41, 42, the drive assembly 1 can be adapted to different vehicles 100 in a particularly simple and cost-efficient manner.

What is claimed is:

1. A drive assembly of a vehicle which can be operated by means of muscle power and/or motor power, the drive assembly comprising:
a drive unit;
a frame interface, wherein the drive unit is disposed at least partially between a first wall (31) and a second wall of the frame interface, and the drive unit includes a through-bore;
two sleeves which are inserted into the through-bore of the drive unit on both sides; and
a through-bolt which is inserted through the through-bore and the two sleeves and holds the drive unit on each of the first and second walls, wherein the through-bolt braces the first and second walls against one another.

2. The drive assembly according to claim 1, wherein each sleeve of the two sleeves includes a shank and a flange, wherein the shank is disposed inside the through-bore, and the flange is disposed outside the through-bore.

3. The drive assembly according to claim 2, wherein each sleeve of the two sleeves includes a damping element which is disposed on a side of the flange of the sleeve facing the drive unit, and wherein the damping element is made of a vibration-damping material.

4. The drive assembly according to claim 3, wherein the damping element at least partially surrounds the shank.

5. The drive assembly according to claim 1, wherein the two sleeves are configured such that, when they are fully inserted into the through-bore and not braced, there is a predefined axial spacing between the two sleeves inside the through-bore.

6. The drive assembly according to claim 5, wherein the predefined axial spacing is configured such that, in a braced state, the axial spacing is compensated by the bracing by the through-bolt and by elastic deformation of the damping element.

7. The drive assembly according to claim 1, wherein the two sleeves touch inside the through-bore, and wherein the two sleeves are configured such that the two sleeves are clamped between the first and second walls by a screw connection via the through-bolt.

8. The drive assembly according to claim 7, wherein the two sleeves and the drive unit are configured such that the drive unit is held between the first and second walls without tension.

9. The drive assembly according to claim 7, wherein the first wall includes a predetermined bending point.

10. The drive assembly according to claim 2, wherein the shank of each sleeve of the two sleeves includes a pressing region, and a press fit is formed between the pressing region and the through-bore.

11. The drive assembly according to claim 10, wherein the pressing region is disposed adjacent to the flange of each sleeve of the two sleeves, and the shank of each sleeve of each of the two sleeves further includes a tapering region which has a smaller outer diameter than the pressing region of the sleeve.

12. The drive assembly according to claim 1, wherein the through-bore includes a centering region in a center, which has a smaller inner diameter than the rest of the through-bore, for centering the two sleeves.

13. The drive assembly according to claim 1, wherein the through-bolt is a screw, and wherein the through-bolt is screwed into an internal thread of the second wall.

14. The drive assembly according to claim 1, wherein the through-bolt is a screw, and the through-bolt is screwed into a nut disposed on the second wall.

15. The drive assembly according to claim 14, wherein the nut is disposed in a non-rotatable manner in a recess of the second wall.

16. The drive assembly according to claim 2, wherein the shank of each sleeve of the two sleeves is inserted into the through-opening of the drive unit, wherein the flange of each sleeve includes a plurality of projecting form-fit elements on a side facing a respective wall of the first and second walls, and wherein the form-fit elements are configured to press into the respective wall as a result of screwing to the respective wall.

17. The drive assembly according to claim 16, wherein each form-fit element of the form fit elements includes a pyramid or a cone, which projects from a surface of the flange of each sleeve of the two sleeves.

18. The drive assembly according to claim 17, wherein each form-fit element of the form fit elements includes a recess in the surface of the flange adjacent to the pyramid.

19. The drive assembly according to claim 1, wherein at least one sleeve of the two sleeves includes a shank and a flange, wherein the flange includes a taper at a radially outer end and on a side facing the shank, and wherein the taper is compensated by the damping element.

20. The drive assembly according to claim 19, wherein the drive unit includes at least one projecting annular rib which is disposed concentrically to one of the through-opening, wherein the projecting annular rib and the taper of the flange of the at least one sleeve are disposed on a same radius with respect to a bore axis of the through-bore.

21. The drive assembly according to claim 2, wherein: (i) the flange of at least one sleeve of the two sleeves has a thickness that corresponds substantially to a wall thickness of the shank of the at least one sleeve, or (ii) the flange of at least one sleeve of the two sleeves has a thickness that corresponds to at least 1.5 times a wall thickness of the shank the at least one sleeve.

22. A vehicle which can be operated by means of muscle power and/or motor power, the vehicle being an electric bicycle, the vehicle comprising:
a drive assembly including:
a drive unit,
a frame interface, wherein the drive unit is disposed at least partially between a first wall (31) and a second wall of the frame interface, and the drive unit includes a through-bore,
two sleeves which are inserted into the through-bore of the drive unit on both sides, and
a through-bolt which is inserted through the through-bore and the two sleeves and holds the drive unit on each of the first and second walls, wherein the through-bolt braces the first and second walls against one another.

23. The vehicle according to claim 22, further comprising:
a chainring which is connected to an output shaft of the drive unit, and wherein the second wall of the drive assembly is disposed on a side of the chainring.
